(19) United States
(12) Patent Application Publication
(10) Pub. No.: US 2023/0242138 A1
(43) Pub. Date: Aug. 3, 2023

(54) METHOD AND DEVICE FOR EVALUATING DRIVER BY USING ADAS

(71) Applicant: SOCAR, INC., Jeju-do (KR)

(72) Inventors: Ju Heon CHOI, Seoul (KR); Min Seok SUNG, Gyeonggi-do (KR); Seung Eun KANG, Seoul (KR)

(21) Appl. No.: 18/011,905

(22) PCT Filed: Jun. 15, 2021
(86) PCT No.: PCT/KR2021/007508

§ 371 Date: Dec. 21, 2022

(30) Foreign Application Priority Data
Jul. 3, 2020 (KR) 10-2020-0082314

(51) Int. Cl. B60W 50/14; B60W 40/09; B60Q 9/00

(52) U.S. Cl. CPC B60W 50/14; B60Q 9/008; B60W 40/09; B60W 2050/0022

(57) ABSTRACT

A method for evaluating a driver in a vehicle having an advanced driver assistance system according to an embodiment includes collecting vehicle traveling information including the movement distance and movement time of a vehicle, extracting a physical property value on the basis of the vehicle traveling information, receiving a notification from the advanced driver assistance system, calculating a personal characteristic notification index value by non-dimensionalizing the notification according to the physical property value, and calculating a reckless driving index value on the basis of the personal characteristic notification index value, the weight for each notification, and a property correction coefficient.

### CROSS REFERENCE TO RELATED APPLICATIONS AND CLAIM OF PRIORITY

This application claims benefit under 35 U.S.C. 119 (e), 120, 121, or 365 (c), and is a National Stage entry from International Application No. PCT/KR2021/007508, filed Jun. 15, 2021, which claims priority to the benefit of Korean Patent Application No. 10-2020-0082314 filed in the Korean Intellectual Property Office on July 03,2020, the entire contents of which are incorporated herein by reference.

### BACKGROUND

### 1. Technical Field

The present invention relates to a method for evaluating a driver, more specifically, to a driver evaluation technology using advanced driver assistance systems (ADAS) that enables accurate driver evaluation by calculating a driver’s reckless driving index based on a notification received from the ADAS equipped in a vehicle and vehicle traveling information collected in real time.

### 2. Background Art

The advanced driver assistance systems (ADAS) or ADAS is a driver assistance system that can prevent accidents by automatically controlling the vehicle by recognizing and/or judging the surrounding situation by the vehicle itself while traveling, or by notifying the driver of a detected risk factor in advance using a precision positioning device such as various advanced detection sensors and a global positioning system (GPS) receiver, a state-of-the-art map, a wireless communication device for vehicle to everything (V2X) communication, radar, lidar, intelligent video equipment including various cameras, etc.

Representative advanced driver assistance systems include smart cruise control (SCC) that detects a distance to a vehicle ahead through a front radar and maintains a vehicle speed and distance set by a driver, advanced emergency braking (AEB), which detects a forward collision situation while traveling and automatically activates a braking device to decelerate or stop the vehicle for the purpose of mitigating or avoiding the collision, forward collision avoidance assist (FCA) which is an active traveling safety system that uses a dual sensor system based on a front camera and radar to recognize a vehicle, a pedestrian, and a cyclist ahead, and warns the driver of danger when a collision with them is expected and controls braking and steering of the vehicle, a lane departure warning (LDW) system which notifies the driver through vibration of a steering wheel or a warning sound when the driver attempts to depart a lane without operating a direction indicator light by recognizing the lane by the front camera, a lane keeping assist (LKA) system which automatically controls the steering wheel more actively to keep the vehicle in the traveling lane, not just a warning alarm when the vehicle departs from the lane, etc.

Recently, a system for calling and reserving the vehicle through various apps and a vehicle sharing service app have been activated.

However, these apps currently do not provide accurate driver evaluation information to users.

In addition, the conventional transportation service provider was able to check the hired driver’s speeding and reckless driving through a black box screen provided in the vehicle when a problem occurs, but there was no way to accurately evaluate the driver based on traveling data.

### SUMMARY

An embodiment of the present invention is to provide a method and device for evaluating a driver using ADAS.

Another embodiment of the present invention is to provide a method and device for evaluating a driver using ADAS capable of evaluating the driver by calculating the driver’s reckless driving index based on vehicle traveling data collected in real time and an ADAS notification.

Another embodiment of the present invention is to provide a method and device for evaluating a driver using ADAS capable of more accurately calculating the reckless driving index and score of the driver by applying the weight and the optimized correction coefficient that makes maximize a probability of accident for each ADAS notification the highest through machine learning.

The technical problems of the present invention are not limited to the technical problems mentioned above, and other technical problems not mentioned will be clearly understood by those skilled in the art from the following description.

A method for evaluating a driver in a vehicle equipped with an advanced driver assistance system according to an embodiment of the present invention may include the steps of collecting vehicle traveling information including a movement distance and movement time of the vehicle, extracting a physical property value based on the vehicle traveling information, receiving a notification from the advanced driver assistance system, calculating a personal characteristic notification index value by non-dimensionalizing the notification according to the physical property value, and calculating a reckless driving index value based on the personal characteristic notification index value, a weight for each notification, and a property correction coefficient.

In an embodiment, the step of non-dimensionalizing the notification based on the physical property value may include the steps of determining a dimensional constant for non-dimensionalizing different dimensions for each notification, and calculating the non-dimensionalized personal characteristic notification index value by applying the movement distance, the movement time, and the dimensional constant to the notification.

In an embodiment, the personal characteristic notification index value Adᵢ corresponding to an i-th received notification Aᵢ is calculated by Equation

$$A {d}_{i} = \frac{{A}_{i}}{{t}^{{p}_{i}} ∗ {d}^{{q}_{i}}} ∗ {K}_{i} ,$$

where pᵢ may be a dimensional constant corresponding to the movement time, qᵢ may be a dimensional constant corresponding to the movement distance, and Kᵢ may be a unit correction constant.

In an embodiment, the pᵢ and the qᵢ may be dynamically updated based on at least one of a type of the notification corresponding to the vehicle traveling information, an accident occurrence frequency, a probability of occurrence of an accident, and a repair cost incurred per accident.

In an embodiment, the method for evaluating the driver may further include a step of determining the weight for each notification and a step of calculating the property correction coefficient for each notification, and the weight for each notification may be determined through a step of identifying an accident occurrence notification among the received notifications and logistic regression analysis of accident data corresponding to the accident occurrence notification.

In an embodiment, the reckless driving index value F_{d} is calculated by Equation

$$F d = {\sum }_{i = F C W}^{n} {α}_{i} ∗ {β}_{i} ∗ log \left(A {d}_{i} + {K}^{′}\right) ∗ {K}^{″} ,$$

where αᵢ may be the weight corresponding to the i-th notification, βᵢ may be a property correction coefficient corresponding to the i-th notification, and K′ and K″ may be unit correction coefficients.

In an embodiment, the method for evaluating the driver may further include a step of calculating a total reckless index of the corresponding driver based on the reckless driving index value calculated for each running, wherein the total reckless index F_{dtotal} is calculated by Equation

$$F {d}_{t o t a l} = \frac{{\sum }_{i = 0}^{n} F {d}_{i} ∗ {d}_{i} ∗ {τ}^{i}}{{\sum }_{i = 0}^{n} {d}_{i} ∗ {τ}^{i}} ,$$

where n may be the total number of times of running, Fdᵢ may be a reckless driving index value corresponding to an (n - i)-th running, dᵢ may be a movement distance corresponding to the (n - i)-th running, and τ may be a time constant between 0 and 1.

In an embodiment, the weight and the property correction coefficient may be pre-calculated through machine on cumulative collected vehicle travel information, the notification, and the accident data, and then used to calculate the reckless driving index value.

In an embodiment, the method for evaluating the driver may further include a step of calculating a driver’s driving score based on the total reckless index Fdₜₒₜₐₗ, and the driving score Score may be calculated by Equation

$$\begin{matrix}S c o r e = ζ ∗ 100 \left(1 - \frac{1}{1 + {e}^{- \frac{F {d}_{t o t a l}}{\text{T}}}}\right) \\ \begin{matrix}ζ = \text{scoring constant 1} \\ \text{T} = \text{scoring constant 2}\end{matrix} .\end{matrix}$$

In an embodiment, the notification may include at least one of a lane departure warning (LDW) notification, a forward collision warning (FCW) notification, a pedestrian collision warning (PCW) notification, a traffic sign recognition (TSR) notification, a speed limit warning (SLW) notification, and a headway monitoring & warning (HMW) notification.

A system for evaluating a driver according to another embodiment of the present invention may include a traveling information providing system that collects and provides vehicle traveling information, an advanced driver assistance system that outputs various notifications based on the vehicle traveling information, and a device for evaluating the driver that calculates a driver’s driving score through machine learning based on the vehicle traveling information and the notification.

A device for evaluating a driver interworking with an advanced driver assistance system and a traveling information providing system according to another embodiment of the present invention may include a vehicle traveling information collection unit that collects vehicle traveling information including a movement distance and movement time of a vehicle from the traveling information providing system, a physical property value extraction unit that extracting a physical property value based on the vehicle traveling information, a notification receiving unit that receives a notification from the advanced driver assistance system, a personal characteristic notification index calculation unit that calculates a personal characteristic notification index value by non-dimensionalizing the notification according to the physical property value, and a reckless driving index calculation unit that calculates a reckless driving index value based on the personal characteristic notification index value, a weight for each notification, and a property correction coefficient.

In an embodiment, the device for evaluating the driver may further include a weight determination unit that determines the weight for each notification and a property correction coefficient determination unit that determines the property correction coefficient for each notification.

In an embodiment, the device for evaluating the driver may further include a total recklessness index calculation unit that calculates a total recklessness index of the driver based on the reckless driving index value calculated for each running, and

the total reckless driving index value Fdₜₒₜₐₗ may be calculated by Equation

$$F {d}_{t o t a l} = \frac{{\sum }_{i = 0}^{n} F {d}_{i} ∗ {d}_{i} ∗ {τ}^{i}}{{\sum }_{i = 0}^{n} {d}_{i} ∗ {τ}^{i}} ,$$

wherein n may be the total number of times of running, Fdᵢ may be a reckless driving index value corresponding to an (n - i)-th running, dᵢ may be a movement distance corresponding to the (n - i) -th running, and τ may be a time constant between 0 and 1.

In an embodiment, the weight and the property correction coefficient may be pre-calculated through machine learning on cumulative collected vehicle traveling information, the notification, and the accident data, and then used to calculate the reckless driving index value.

In an embodiment, the device for evaluating the driver may further include a driving score calculation unit that calculates a driver’s driving score based on the total reckless index Fdₜₒₜₐₗ, and the driving score Score may be calculated by Equation

$$\begin{matrix}S c o r e = \text{ζ} ∗ 100 \left(1 - \frac{1}{1 + {e}^{- \frac{F {d}_{t o t a l}}{\text{T}}}}\right) \\ \begin{matrix}\text{ζ} = \text{scoring constant 1} \\ \text{T} = \text{scoring constant 2}\end{matrix} .\end{matrix}$$

The technical problems to be achieved in the present invention are not limited to the technical problems mentioned above, and other technical problems not mentioned will be clearly understood by those of ordinary skill in the art to which the present invention belongs from the description below.

The present invention has an advantage of providing a method and device for evaluating a driver using ADAS.

Further, the present invention has an advantage of providing a method and device for evaluating a driver using ADAS capable of evaluating the driver by calculating the driver’s reckless driving index based on vehicle traveling data collected in real time and an ADAS notification.

Further, the present invention has an advantage of providing a method and device for evaluating a driver using ADAS capable of more accurately calculating the reckless driving index and score of the driver by applying the weight and the optimized correction coefficient that makes a probability of accident for each ADAS notification the highest through machine learning.

In addition to these effects, various effects identified directly or indirectly through this document may be provided.

### BRIEF DESCRIPTION OF THE DRAWINGS

FIG. 1 is a block diagram for illustrating a structure of a system for evaluating a driver according to an embodiment of the present invention.

FIG. 2 is a block diagram for illustrating a detailed structure of the system for evaluating the driver according to the embodiment of FIG. 1.

FIG. 3 is a flowchart for describing a method for evaluating a driver in the device for evaluating the driver according to an embodiment of the present invention.

FIG. 4 is a flowchart for describing the method for evaluating the driver of FIG. 3 in more detail.

FIG. 5 is a flowchart for describing a method for evaluating a driver according to another embodiment of the present invention.

FIG. 6 is a flowchart for describing a method for determining a weight for each notification according to an embodiment of the present invention.

FIG. 7 is a histogram of reckless driving index showing an analysis result of reckless driving index values for a plurality of drivers.

FIG. 8 is a screen showing a driver evaluation result in the device for evaluating the driver according to an embodiment.

FIG. 9 is a diagram for describing a method for evaluating a driver according to another embodiment of the present invention.

### DETAILED DESCRIPTION

Hereinafter, some embodiments of the present invention will be described in detail with reference to illustrative drawings. In adding reference numerals to the components of each drawing, it should be noted that the same components are given the same reference numerals as much as possible even though the components are indicated on different drawings. In addition, in describing the embodiments of the present invention, if it is determined that a detailed description of a related known configuration or function interferes with the understanding of the embodiments of the present invention, the detailed description thereof will be omitted.

In describing the components of the embodiment of the present invention, terms such as first, second, A, B, (a), (b), etc. may be used. These terms are only for distinguishing the components from other components, and the essence, sequence, or order of the components are not limited by the terms. In addition, unless otherwise defined, all terms used herein, including technical or scientific terms, have the same meaning as those commonly understood by a person ordinary skilled in the art to which this invention belongs. Terms such as those defined in a commonly used dictionary should be interpreted as having a meaning consistent with the meaning in the context of the related art, and are not to be construed in an ideal or overly formal meaning unless explicitly defined in the present application.

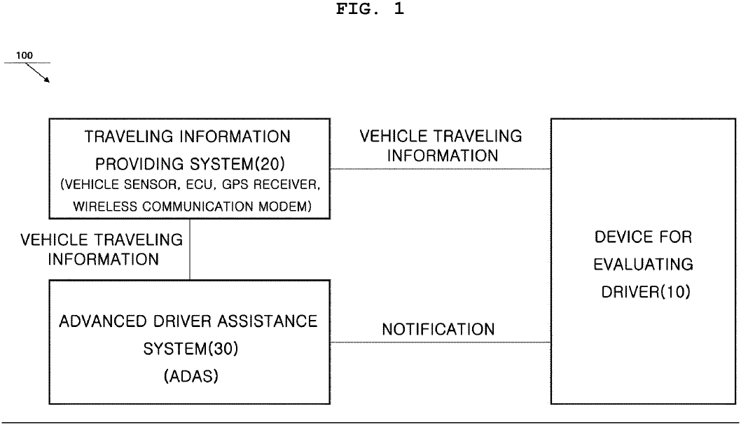

Hereinafter, embodiments of the present invention will be described in detail with reference to FIGS. 1 to 7.

FIG. 1 is a block diagram for illustrating a structure of a system for evaluating a driver according to an embodiment of the present invention.

Referring to FIG. 1, a system 100 for evaluating a driver may be largely configured to include a device 10 for evaluating a driver, a traveling information providing system 20, and an advanced driver assistance system (ADAS) 30.

The device 10 for evaluating the driver may collect various types of vehicle traveling information from the traveling information providing system 20 while traveling. As an example, the vehicle traveling information may include movement time information and movement distance information, but is not limited thereto. Various vehicle traveling information may be received from various sensors and cameras provided in the vehicle, an electronic control unit (ECU), a global positioning system (GPS) receiver, a wireless communication modem for vehicle to everything (V2X) communication, etc.

The device 10 for evaluating the driver may receive various notifications from the ADAS 30.

The device 10 for evaluating the driver may receive not only the notification but also predetermined additional data for each notification from the ADAS.

The device 10 for evaluating the driver may calculate a reckless driving index value and driving score of the driver by performing machine learning based on vehicle traveling information and notifications.

The ADAS 30 may acquire the vehicle traveling information from the traveling information providing system 20 and output various notifications.

As an example, the notification may include a lane departure alarm notification, a vehicle collision alarm notification, a safe distance non-maintenance alarm notification, a pedestrian collision alarm notification, a traffic signal recognition notification, a speed limit indication notification, etc., but is not limited thereto.

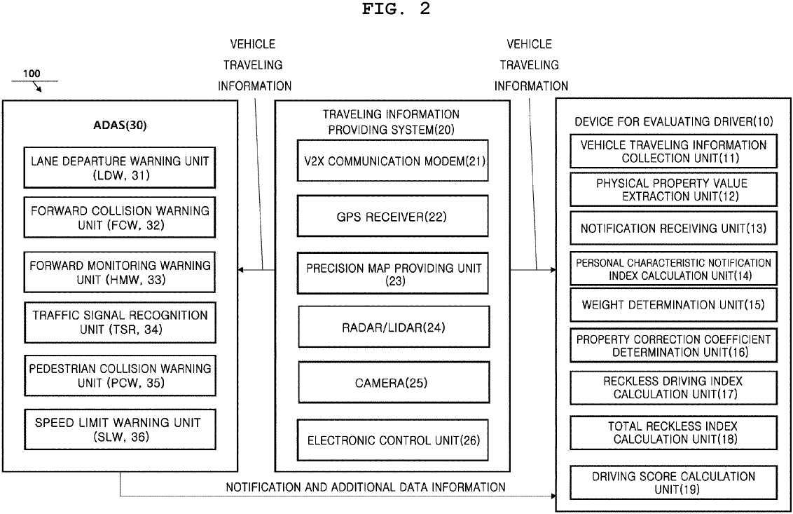

FIG. 2 is a block diagram for illustrating a detailed structure of the system for evaluating a driver according to the embodiment of FIG. 1 described above.

Referring to FIG. 2, the device 10 for evaluating the driver may be configured to include a vehicle traveling information collection unit 11, a physical property value extraction unit 12, a notification receiving unit 13, a personal characteristic notification index calculation unit 14, a weight determination unit 15, a property correction coefficient determination unit 16, a reckless driving index calculation unit 17, a total reckless driving index calculation unit 18, and a driving score calculation unit 19.

The vehicle traveling information collection unit 11 may collect the vehicle traveling information from the traveling information providing system 20 while running. As an example, the vehicle traveling information may include, but is not limited to, a running distance and running time, and may further include information on personal driving habits and surrounding environment (e.g., running region and road type information, etc.).

The physical property value extraction unit 12 may extract a physical property value based on the vehicle traveling information. As an example, the physical property value may include an average speed, average energy per unit mass, average acceleration, etc.

The physical property value extraction unit 12 may extract a physical correlation between the physical property value and an actual accident magnitude or accident handling cost, and the number of number of occurrences of notifications.

The notification receiving unit 13 may receive various notifications from the ADAS (30).

As an example, the notification may include a lane departure warning (LDW) notification, a forward collision warning (FCW) notification, a pedestrian collision warning (PCW) notification, a traffic sign recognition (TSR) notification, a speed limit warning (SLW) notification, a headway monitoring & warning (HMW) notification, etc.

The personal characteristic notification index calculation unit 14 may calculate a personal characteristic notification index value (i.e., the dimensionless number) by non-dimensionalizing the received notification according to the physical property value.

The weight determination unit 15 may determine a weight so that a higher weight is applied to a notification that increases an actual accident probability.

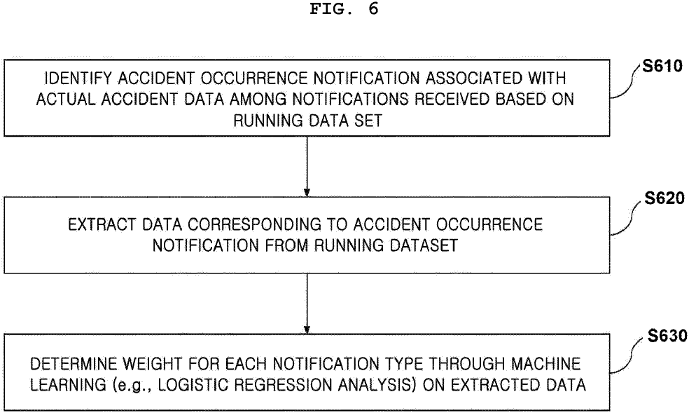

A method of determining the weight by the weight determination unit 15 will be more clearly described with reference to FIG. 6, which will be described later.

The property correction coefficient determination unit 16 may determine a property correction coefficient for correcting the dimensionless number by using additional data information acquired from the ADAS 30 in response to each notification.

As an example, the property correction coefficient determination unit 16 may correct the dimensionless number by using the property correction coefficient calculated by additionally reflecting normal lane change data to the LDW notification, that is, a warning notification for notifying an abnormal lane change in a state in which a turn indicator (or steering indicator) is not turned on.

The reckless driving index calculation unit 17 may calculate the reckless driving index value of the corresponding driver for each running based on the dimensionless number, the weight, the property correction coefficient, etc.

The recklessness index calculation unit 17 may calculate the total recklessness index of the corresponding driver based on the reckless driving index value calculated for each running.

The driving score calculation unit 19 may calculate the driving score of the corresponding driver based on the reckless driving index value.

The detailed operation of the sub-modules constituting the device 10 for evaluating the driver will become clearer through the description of the drawings to be described later.

The traveling information providing system 20 may be configured to include a V2X communication modem 21, a GPS receiver 22, a precision map providing unit 23, a radar/lidar 24, a camera 25, and an electronic control unit 26.

The V2X communication modem 21 may acquire various traveling information by performing vehicle to infrastructure (V2I) communication and/or vehicle vehicle to vehicle (V2V) communication and/or vehicle to pedestrian (V2P) communication.

The V2X communication modem 21 may acquire traffic accident information, traffic situation information, surrounding pedestrian information, surrounding vehicle traveling information, etc.

The GPS receiver 22 may may acquire current location information of the vehicle and current time information by receiving a positioning satellite signal.

The precise map providing unit 23 may provide a precise map corresponding to the current location of the vehicle.

The radar/lidar 24 may detect an object in front, side, and rear of the vehicle, and calculate a distance to the detected object.

In addition, the radar/lidar 24 may provide information on the condition of the traveling road and surrounding facilities through high-resolution terrain scans.

The camera 25 may largely include an external camera for photographing the outside of the vehicle and an internal camera for photographing a driver inside the vehicle.

The vehicle external camera of the vehicle can photograph images of the front, side, and rear of the vehicle. To this end, the vehicle may be provided with a plurality of external cameras.

The image information captured by the vehicle external camera can be used for lane discrimination, identification of obstacles and pedestrians around the vehicle, and augmented reality implementation, etc.

The vehicle internal camera can be used to photograph the driver and an occupant.

The images photographed by the vehicle interior camera can be used to monitor driver fatigue, drowsy driving, attention distraction, etc.

The electronic control unit 26 may include various electronic control units for controlling a steering system, a shift system, a drive system, a braking system, a posture control system, a direction indicator, and an emergency flashing indicator of the vehicle.

The ADAS 30 may be configured to include a lane departure warning unit (LDW unit) 31, a forward collision warning unit (FCW unit) 32, a forward monitoring warning unit (HMW unit) 33, a traffic signal recognition unit (TSR unit) 34, a pedestrian collision warning unit (PCW unit) 35, and a speed limit warning unit (SLW unit) 36.

The lane departure warning unit 31 may control to output a visual and/or audible alarm notification when detecting a situation in which the driver departs from the driving lane without turning on the steering indicator.

In addition, the lane departure warning unit 31 may detect a situation in which the driver departs from the driving lane while the steering indicator is normally turned on, and provide corresponding event information to the device 10 for evaluating the driver.

The forward collision warning unit 32 may continuously monitor the image taken through the camera installed in front of the vehicle to detect other vehicles or motorcycles on a running route, and calculate the relative speed between its own vehicle and the other vehicle. When the forward collision warning unit 32 detects an emergency situation in which a forward collision is imminent based on the calculated relative speed, the forward collision warning unit 32 may transmit the forward collision warning notification to the device 10 for evaluating the driver.

In addition, the forward collision warning unit 32 may output a predetermined warning notification through an alarm sound and visual alarm means (e.g., a warning light or a display mounted on one side of the rear side of the vehicle) when detecting the risk of a front collision to inform a rear vehicle of an emergency situation with the vehicle in front.

The forward monitoring warning unit 33 may monitor a distance from the front vehicle in the high-speed driving situation and control so that the alarm notification is output when the risk of an accident increases.

When the traffic signal recognition unit 34 recognizes a traffic signal (e.g., a traffic light) around the traveling road, the traffic signal recognition unit 34 may control so that a notification including a traffic signal recognition result is output.

The pedestrian collision warning unit 35 may identify a pedestrian through a movement direction and pattern analysis of an object, determine the risk of collision with the identified pedestrian, and control so that a pedestrian collision alarm notification is output.

The speed limit warning unit 36 may recognize a speed limit sign on the road and/or around the road and control so that a speed limit alarm notification is output to the driver and the device 10 for evaluating the driver when the speed limit is exceeded.

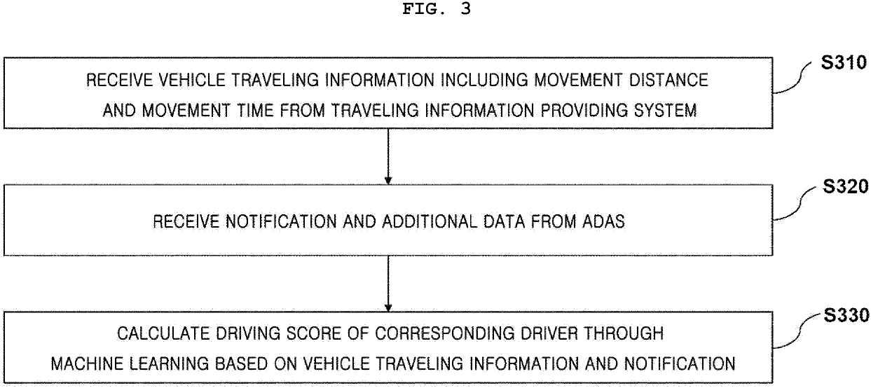

FIG. 3 is a flowchart for describing a method for evaluating a driver in the device for evaluating the driver according to an embodiment of the present invention.

Referring to FIG. 3, the device 10 for evaluating the driver may receive vehicle traveling information including the movement distance and the movement time from the traveling information providing system 20 while traveling (S310).

The device 10 for evaluating the driver may receive a notification from the ADAS 30 while traveling (S320).

The device 10 for evaluating the driver may calculate a driving score of the corresponding driver through machine learning based on the vehicle traveling information and notification (S330).

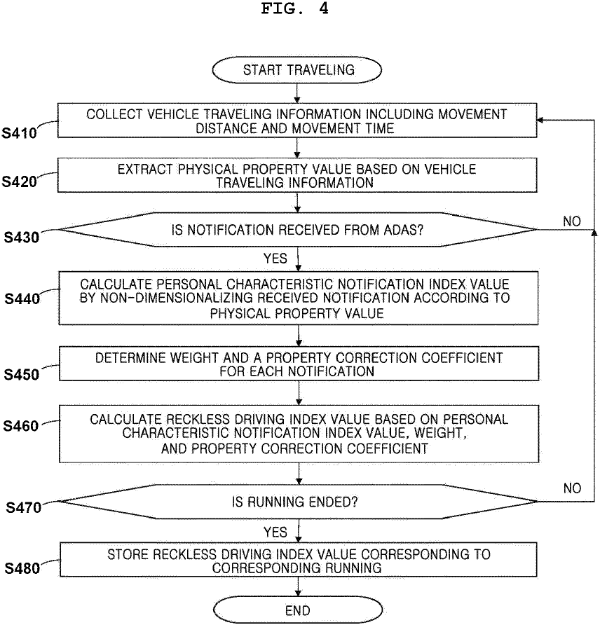

FIG. 4 is a flowchart for describing the method for evaluating the driver of FIG. 3 in more detail.

Referring to FIG. 4, when vehicle running starts, the device 10 for evaluating the driver may collect vehicle traveling information including the movement distance and the movement time (S410).

The device 10 for evaluating the driver may extract a physical property value based on the vehicle traveling information (S420).

As an example, the physical property value may include an average vehicle speed, average energy per unit mass, and average acceleration.

When the total movement distance of the corresponding running is dₜₒₜₐₗ and the total movement time is t_{total′} the average vehicle speed ν_{average} can be calculated by the following equation.

$${v}_{a v e r a g e} = \frac{{d}_{t o t a l}}{{t}_{t o t a l}} = \frac{\text{movement}}{\text{time}}$$

The average energy ε_{average}per unit mass can be calculated by the following equation.

$${ε}_{a v e r a g e} = \frac{{E}_{a v e r a g e}}{m} = \frac{1}{2} ∗ {v}_{a v e r a g e} {}^{2} = \frac{1}{2} ∗ {\left(\frac{{d}_{t o t a l}}{{t}_{t o t a l}}\right)}^{2} \left({m}^{2} / {s}^{2}\right)$$

The average acceleration, which can be defined as the average energy per unit mass per movement distance, can be calculated by the following equation.

$$\frac{{ε}_{a v e r a g e}}{{d}_{t o t a l}} = \frac{1}{2} ∗ \frac{{v}_{a v e r a g e} {}^{2}}{{d}_{t o t a l}} = \frac{1}{2} ∗ \frac{{\left(\frac{{d}_{t o t a l}}{{t}_{t o t a l}}\right)}^{2}}{{d}_{t o t a l}} = \frac{1}{2} ∗ \frac{{d}_{t o t a l}}{{t}_{t o t a l} {}^{2}} \left(m / {s}^{2}\right)$$

In addition, various physical property values may be extracted through an exponential expression of the movement time and the movement distance, as described below.

$$\sqrt{\frac{{ε}_{a v e r a g e}}{{d}_{t o t a l}}} = \sqrt{\frac{1}{2} ∗ \frac{{d}_{t o t a l}}{{t}_{t o t a l} {}^{2}}} \left({m}^{\frac{1}{2}} / s\right)$$

$$\frac{1}{{v}_{a v e r a g e}} = \frac{{t}_{t o t a l}}{{d}_{t o t a l}} \left(s / m\right)$$

The physical property value may have deep relevancy with an actual accident magnitude (cost or accident repair cost), an accident occurrence frequency, the number of occurrences of notifications, etc.

As an example, as the average vehicle speed ν_{average} increases, the accident repair cost RepairCost increases, and as the average vehicle speed decreases, the accident occurrence frequency may increase. In addition, as the movement distance increases, the number of occurrences of notification may increase.

The following equation is an exemplarily equation showing the relevancy between the physical property value, the accident repair cost, the accident occurrence frequency, and the number of occurrences of notification.

$${v}_{a v e r a g e} ∝ R e p a i r C o s t$$

$$\frac{1}{{v}_{a v e r a g e}} ∝ \text{accident occurence frequency}$$

$${A}_{L D W \_ R I G H T} ∝ {d}_{t o t a l} {}^{0.7} \left(\text{movement distance}\right)$$

When the notification is non-dimensionalized in consideration of the physical property value described above, a pure driving pattern component of the driver may be analyzed. If the driving pattern is analyzed without considering the physical relevancies described above, the same conclusion may be reached that the more people who drive more distance, the higher the accident occurrence frequency.

Therefore, it is important to calculate the personal characteristic value of the driver in consideration of all of the movement distance, movement time, and notification information.

The frequency of notifications from the ADAS 30 has a correlation with the movement distance and the movement time, as described above. Accordingly, the notification may be assumed as a function of time and distance, and may be expressed within three dimensions in consideration of the kinetic energy dimension of the vehicle, as in the following equation.

$$\begin{matrix}{A}_{i} \left(t , d\right) \left({m}^{μ} {s}^{v}\right) \\ - 3 < μ < 3 \\ - 3 < v < 3\end{matrix}$$

The frequency of notifications is related to personal driving habits, surrounding environments (e.g., city driving, highway driving, etc.) and vehicle speed.

In addition, the notification received from the ADAS 30 is closely related to the occurrence of an actual accident.

As an example, in the case of the safety distance maintenance alarm notification, and the safety distance maintenance alarm notification is frequently generated during commuting time with a large number of vehicles, and the probability of occurrence thereof may be higher as the vehicle average speed is lower.

As another example, in the case of the forward pedestrian warning notification, the forward pedestrian warning notification is more likely to occur on an alleyway than on a road dedicated to automobiles or a highway, and the probability of occurrence thereof may be higher as the average vehicle speed is lower.

As another example, even at the same driving speed, as the number of occurrences of specific notifications increases, the probability of occurrence of an accident and the repair cost when the accident occurs may increase.

The device 10 for evaluating the driver may monitor whether or not a notification is received from the ADAS 30 (S430) .

When the notification is received, the device 10 for evaluating the driver may calculate a personal characteristic notification index value by non-dimensionalizing the received notification according to the physical property value (S440).

When the notification received from the ADAS 30 can be expressed as a function of the movement time and the movement distance, as described above, the device 10 for evaluating the driver may calculate a non-dimensionalized notification value Adᵢ (hereinafter, for simplicity, it will be referred to as ‘dimensionless number or personal characteristic notification index value’) obtained by applying a unit correction constant Kᵢ corresponding to an i-th notification and a time-dimensional constant pᵢ and a distance-dimensional constant qᵢ corresponding to the i-th notification to an i-th received notification Aᵢ, according to the following equation.

$$A {d}_{i} = \frac{{A}_{i}}{{t}^{{p}_{i}} ∗ {d}^{{q}_{i}}} ∗ {K}_{i}$$

Since each notification has a different physical dimension, the dimensional constants p and q may be determined differently through machine learning based on data such as the accident occurrence frequency, the probability of occurrence of an accident, the repair cost per accident for each notification type, etc.

When p and q are changed, the frequency of accidents, repair cost per accident, and total repair cost change for each section of the dimensionless number. Accordingly, the values of p and q may be designated as optimal values through machine learning in consideration of the change of the indices described above.

As an example, the p and q may be determined and set so that 10% of accidents are included in the top 20% score of the dimensionless number.

As an example, the right lane change may have the following relational expression with the movement distance.

$${A}_{L D W \_ R I G H T} ∝ {d}_{t o t a l} {}^{0.7} \left(\text{movement distance}\right)$$

In this case, as in the following equation, a personal characteristic with the distance component removed may be created, and the dimensionless number of each notification can be obtained by multiplying the personal characteristic by an average speed.

$$\begin{matrix}\left(\text{personal characteristic}\right) ∗ \text{average speed} \\ = \left(\text{number of notifications} / {\text{movement distance}}^{0.7}\right) ∗ \text{average speed} \\ \text{=} \left(\text{A} / {\text{d}}^{0.7}\right) ∗ {\text{v}}_{\text{average}} = \left(\text{A} / {\text{d}}^{0.7}\right) ∗ \left(\text{d} / \text{t}\right) = \text{A} / \left({\text{d}}^{\text{-0} \text{.3}} \text{t}\right)\end{matrix}$$

The K value used for calculating the dimensionless number may play a role in preventing a value from diverge as shown in the following equation in machine learning such as logistic analysis by matching the unit of the dimensionless number for each notification.

$$\begin{matrix}\frac{{A}_{F C W}}{{t}^{{p}_{F C W}} ∗ {d}^{{q}_{F C W}}} = 0.0002 \\ \frac{{A}_{F C W}}{{t}^{{p}_{F C W}} ∗ {d}^{{q}_{F C W}}} ∗ {K}_{F C W} = 0.0002 ∗ 1000 = 0.2\end{matrix}$$

$$\begin{matrix}\frac{{A}_{L D W}}{{t}^{{p}_{L D W}} ∗ {d}^{{q}_{L D W}}} = 15 \\ \frac{{A}_{L D W}}{{t}^{{p}_{L D W}} ∗ {d}^{{q}_{L D W}}} ∗ {K}_{L D W} = 15 ∗ 0.01 = 0.15\end{matrix}$$

The device 10 for evaluating the driver may determine a weight and a property correction coefficient for each notification (S450).

The device 10 for evaluating the driver may determine the weight so that a higher weight is applied to a notification that increases the actual accident probability.

A method of determining the weight will become clearer through the description of FIG. 6, which will be described later.

The device 10 for evaluating the driver may correct the dimensionless number by using the additional data information acquired from the ADAS 30 in response to each notification.

As an example, the device 10 for evaluating the driver may correct the dimensionless number by additionally reflecting normal lane change data to the LDW notification, that is, a warning notification for notifying an abnormal lane change in a state in which the turn indicator is not turned on.

As an example, the dimensionless number of notifications and the probability of correctly turning on the turn signal when changing lanes in the following two situations are compared.
Situation 1: movement distance 500 km, movement time 10 hours, abnormal lane change 50 times, normal lane change 200 times
Situation 2: movement distance 500 km, movement time 10 hours, abnormal lane change 50 times, normal lane change 20 times

In the above two situations, although the dimensionless number of notifications is the same, the probabilities of correctly turning on the turn signal when changing lanes are 80% in situation 1 and 29% in situation 2, respectively, and are different from each other.

As another example, lane type data may be additionally reflected in the LDW notification as in the following two situations.
Situation 3: movement distance 500 km, movement time 10 hours, white solid line lane change 10 times, white dotted line lane change 0 times
Situation 4: movement distance 500 km, movement time 10 hours, solid white solid line lane change 0 times, white dotted line lane change 10 times

In the above example, since the white solid line lane change is illegal, situation 3 has a higher accident risk degree than situation 4. In addition, the device 10 for evaluating the driver may calculate the property correction coefficient for the lane change notification based on a lane change average lateral speed and an average speed measured through the camera of the ADAS 30 when changing a lane.

The property correction coefficient β_{LDW} for the LDW notification in consideration of lane change data and lane type data according to the example described above may be calculated by the following equation.

$${β}_{L D W} = {\left(\frac{{\sum }_{j = 0}^{m} L D {W}_{j} ∗ {ε}_{j}}{\left(L C {A}_{t o t a l}\right)}\right)}^{r} ∗ {\left(\frac{{v}_{h a v e r a g e}}{{v}_{a v e r a g e}}\right)}^{s}$$

$$\begin{matrix}{\text{ε}}_{\text{j}} = \text{weight for each lane type} \\ {\text{v}}_{\text{h average}} = \text{lateral-direction average speed} \\ {\text{v}}_{\text{average}} = \text{vehicle average speed} \\ \text{r, s} = \text{parameter}\end{matrix}$$

$$L C {A}_{t o t a l} = L D N + {\sum }_{j = \text{white dottd line}}^{\text{lane type}} L D {W}_{j}$$

$$\begin{matrix}{\text{LCA}}_{\text{total}} = \text{total number of lane changes} \\ \text{LDN} = \text{normal lane change} \\ {\text{LDW}}_{\text{j}} = \text{abnormal lane change for each lane type}\end{matrix}$$

Notifications excluding the LDW may be designated as follows according to an LDW correction value range.

$${β}_{F C W} = {β}_{P C W} = {β}_{H M W} = k$$

Hereinafter, a method of calculating the property correction coefficient for the normal lane change will be described as an example.

Table 1 below shows an exemplary weight assignment for each lane change situation for vehicle running, and Table 2 shows an exemplary property correction coefficient calculation process for the normal lane change.

TABLE 1

| | frequency(LDW) | weight (ε) | weighted product(LDW*ε) |
|---|---|---|---|
| LDW (dotted white line) | 5 | 1 | 5 |
| LDW (solid white line) | 10 | 1.3 | 13 |
| normal (white solid white line) | 5 | 0.8 | 4 |
| normal (white dotted white line) | 30 | 0 | 0 |
| LCAₜₒₜₐₗ | 50 | sum of weighted products | 22 |

TABLE 2

| | |
|---|---|
| total/number of times of changes | 0.44 |
| parameter r | 1 |
| parameter r applied value | 0.44 |
| lateral speed | 1.5 |
| average speed | 30 |
| lateral speed/average speed | 0.05 |
| parameter s | 0.5 |
| parameter s applied value | 0.224 |
| property correction coefficient | 0.098 |

The property correction coefficient β_{LDW} corresponding to the LDW notification according to [Table 1] to [Table 2] may be calculated as follows.

$${β}_{L D W} = {\left(\frac{22}{50}\right)}^{1} ∗ {\left(\frac{1.5}{30}\right)}^{0.5} = 0.098$$

The weights shown in [Table 1] can also be designated as values that make the probability of an accident the highest through machine learning analysis such as logistic regression, just like calculating the degree of reliability for each notification.

The device 10 for evaluating the driver may calculate the reckless driving index value based on the personal characteristic notification index value and weight, and the property correction coefficient (S460).

As an example, the reckless driving index value Fd may be calculated by the following equation.

$$F d = {\sum }_{i = F C W}^{n} {α}_{i} ∗ {β}_{i} ∗ log \left(A {d}_{i} + {K}^{′}\right) ∗ {K}^{″}$$

By substituting a dimensionless number, which is a non-dimensionalized ADAS notification, into the above equation, the reckless driving index value Fd can be expressed as follows.

$$F d = {\sum }_{i = F C W}^{n} {α}_{i} ∗ {β}_{i} ∗ log \left(\frac{{A}_{i}}{{t}^{{p}_{i}} ∗ {d}^{{q}_{i}}} ∗ {K}_{i} + {K}^{′}\right) ∗ {K}^{″} ,$$

When machine learning is performed in consideration of the examples described above, an optimized correction coefficient that makes the probability of an accident the highest may be acquired.

The device 10 for evaluating the driver may determine whether or not the running is ended (S470).

As a result of the determination, when the running is ended, the device 10 for evaluating the driver may store the reckless driving index value corresponding to the corresponding running (S480).

As a result of the determination in step 470, when the running is not ended, the device 10 for evaluating the driver may return to step 410 to collect vehicle traveling information.

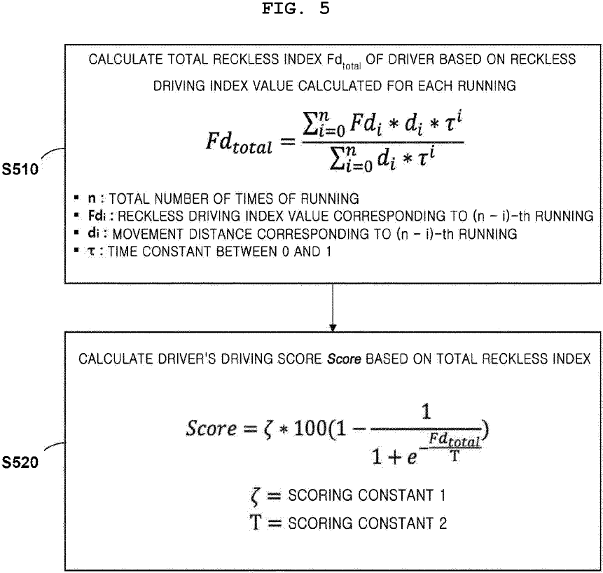

FIG. 5 is a flowchart for describing a method for evaluating a driver according to another embodiment of the present invention.

Referring to FIG. 5, the device 10 for evaluating the driver may calculate the total reckless driving index of the corresponding driver based on the calculated reckless driving index value for each running (S510).

In an embodiment, when there is running data in which the corresponding driver has run at least a specific distance for a predetermined number of times or more, the total reckless driving index Fdₜₒₜₐₗ of the corresponding driver may be calculated by the following equation.

$$F {d}_{t o t a l} = \frac{{\sum }_{i = 0}^{n} F {d}_{i} ∗ {d}_{i} ∗ {τ}^{i}}{{\sum }_{i = 0}^{n} {d}_{i} ∗ {τ}^{i}}$$

where, n may be the total number of times of running, Fdᵢ is a reckless driving index value corresponding to an (n - i)-th running, dᵢ is a movement distance corresponding to the (n - i) -th running, and τ is a time constant between 0 and 1. The larger the i value, the more the past running it means, and the more past the running, the smaller the effect on the total reckless driving index.

The device 10 for evaluating the driver may calculate a total reckless driving driver score (S520).

As an example, the driver score may be calculated through the following conversion equation.

$$\begin{matrix}S c o r e = ζ ∗ 100 \left(1 - \frac{1}{1 + {e}^{- \frac{F {d}_{t o t a l}}{\text{T}}}}\right) \\ \begin{matrix}ζ = \text{scoring constant 1} \\ \text{T} = \text{scoring constant 2}\end{matrix}\end{matrix}$$

The conversion equation is only one embodiment, and the conversion equation and the scoring constant according thereto may be applied in various ways according to the learning model form and score distribution.

FIG. 6 is a flowchart for describing a method of determining a weight for each notification according to an embodiment of the present invention.

Referring to FIG. 6, the device 10 for evaluating the driver may identify a notification (hereinafter, referred to as an “accident occurrence notification” for convenience of explanation) that generated actual accident data among notifications received based on a running data set (S610).

The device 10 for evaluating the driver may extract data corresponding to the accident occurrence notification from the running dataset (S620).

The device 10 for evaluating the driver may determine a weight a for each notification type through machine learning on the extracted data (S630).

As an example, as machine learning used for weight determination, logistic regression analysis used to predict the probability that data belongs to a specific category may be applied, but is not limited thereto.

In an embodiment, categories of data may be classified based on a magnitude of the accident.

For example, in an embodiment, categories of data may be binary classified according to the magnitude of the accident.

For example, the magnitude of the accident may be classified based on the accident repair cost. In this case, a data category yₜᵣₐᵢₙ may be binary classified into a case 1 where the accident repair cost is greater than or equal to a predetermined reference amount n and a case 0 where the accident repair cost is less than the reference amount n.

In the logistic regression analysis according to the embodiment, the probability model that will be 1 for each notification type x may be expressed as follows.

$${y}_{t r a i n} \left\{\begin{matrix}\text{accident repair cost more than} \left(\text{nx10}\right) \text{thousand won 1} \\ \text{accident repair cost less than} \left(\text{nx10}\right) \text{thousand won 1}\end{matrix}\right) \begin{matrix}{x}_{i} = log \left(\frac{{A}_{i}}{{t}^{{p}_{i}} ∗ {d}^{{q}_{i}}} ∗ {K}_{i} + {K}^{′}\right) ∗ {K}^{″} \\ {x}_{t r a i n} = \left(\begin{matrix}{x}_{L D W \_ R I G H T} \\ ⋮ \\ {x}_{F C W}\end{matrix}\right)\end{matrix}$$

The xi is obtained by taking the logarithm of the sum of the dimensionless number Adᵢ of the notification and the unit correction coefficient K′ and then multiplying by the unit correction coefficient K′. In logistic regression analysis, regardless of the value of x, y always has a probability between 0 and 1, and the following logistic function may be expressed as the following sigmoid function.

$$y = \frac{1}{1 + {e}^{- {α}^{T} x}}$$

The device 10 for evaluating the driver may determine the weight for each notification type so that more weights are given to factors that increase the actual accident probability through learning using a method of gradient descent.

As an example, the notification type may include the left/right lane departure warning notification, the forward collision warning notification, the forward monitoring warning notification, the traffic signal recognition notification, the pedestrian collision warning notification, the speed limit warning notification, etc., but is limited thereto.

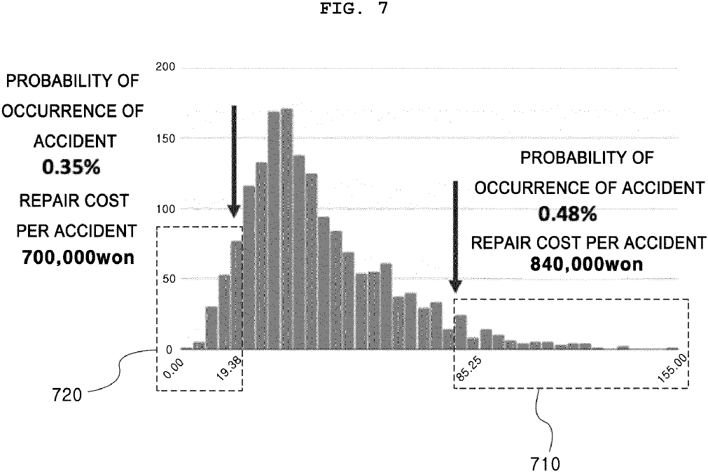

FIG. 7 is a histogram of reckless driving index showing an analysis result of reckless driving index values for a plurality of drivers.

Referring to FIG. 7, the probability of occurrence of an accident in the top 20% (710) of the reckless driving index is 0.48%, and the probability of occurrence of the accident in the bottom 20% (720) of the reckless driving index is 0.35 %, based on an actual dataset collected while traveling. That is, FIG. 7 shows that the top 20% of the reckless driving index has a 37% higher probability of occurrence of an accident than the bottom 20% of the reckless driving index. In addition, FIG. 7 shows that, when an accident occurs, the repair cost per accident is higher by more than 140,000 won in the top 20% (710) of the reckless driving index compared to the bottom 20% (720) of the reckless driving index.

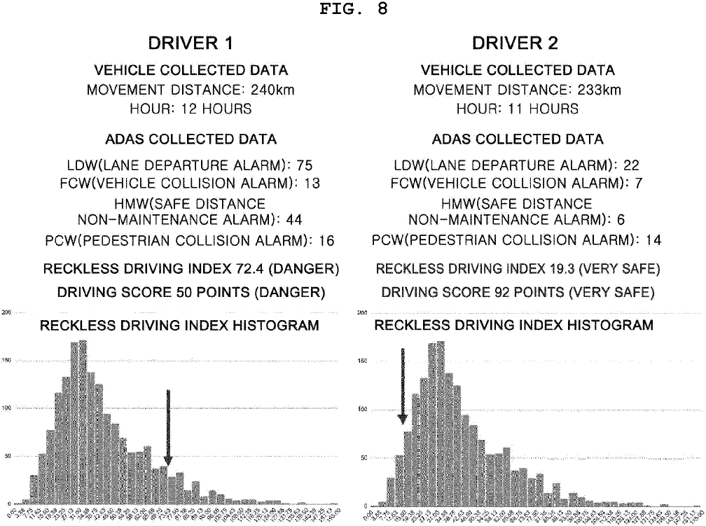

FIG. 8 is a screen showing a driver evaluation result in the device for evaluating the driver according to an embodiment.

Referring to FIG. 8, the driver evaluation result may include vehicle collected data, ADAS collected data, reckless driving index value, driver’s driving score, and reckless driving index histogram, for each driver.

In the above embodiments, it has been described that the weight and the property correction coefficient are calculated based on vehicle traveling information and notification information received in real time, but this is only one embodiment. The weight and the property correction coefficients may be used after being calculated in advance through machine learning based on a pre-collected cumulative dataset.

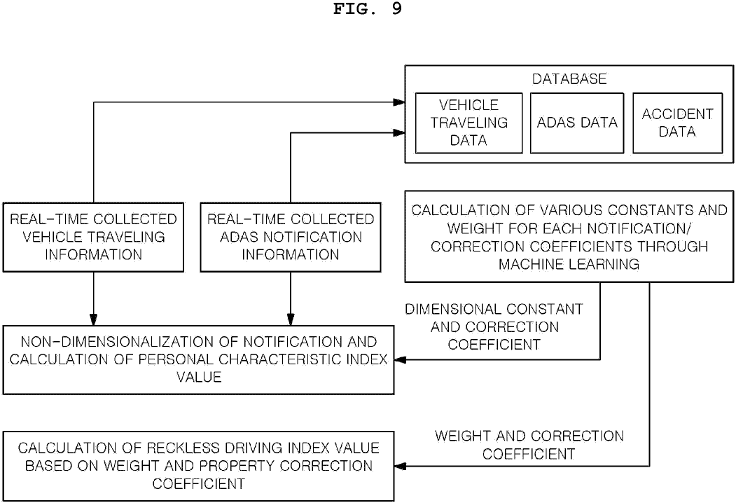

As shown in FIG. 9, the device 10 for evaluating the driver according to the embodiment may calculate various constants (e.g., a dimensional constant and a correction constant), the weight, property correction coefficient, etc. in advance through machine learning for vehicle traveling information, ADAS notification information, and accident data information cumulatively collected and stored in the database, and then store them in a memory (not shown). In this case, values of the constants may be used for non-dimensionalization of the notification and calculation of the personal characteristic index value, and the weight and property correction coefficient may be used for calculating the reckless driving index value. As such, by performing machine learning based on the accumulated, the various constants, the weight, and the property correction coefficient have converged values, and accordingly, a more accurate personal characteristic notification index value, reckless driving index value, and total reckless index, and driving score may be calculated. Steps of a method or algorithm described in connection with the embodiments disclosed herein may be directly implemented in hardware, a software module executed by a processor, or a combination of the two. The software module may reside in a storage medium (i.e., memory and/or storage) such as a RAM memory, a flash memory, a ROM memory, an EPROM memory, an EEPROM memory, registers, a hard disk, a removable disk, a CD-ROM.

An exemplary storage medium is coupled to the processor, the processor can read information from the storage medium and write information to the storage medium. Alternatively, the storage medium may be integral with the processor. The processor and the storage medium may reside within an application specific integrated circuit (ASIC). The ASIC may reside within a user terminal. Alternatively, the processor and storage medium may reside as individual components within the user terminal.

The above description is merely illustrative of the technical idea of the present invention, and various modifications and variations will be made thereto without departing from the essential characteristics of the present invention by those skilled in the art to which the present invention pertains. Therefore, the embodiments disclosed in the present invention are not intended to limit the technical idea of the present invention, but to explain. The scope of the technical idea of the present invention is not limited by these embodiments. The scope of protection of the present invention should be interpreted by the following claims, and all technical ideas within the scope equivalent thereto should be construed as being included in the scope of rights of the present invention.

1. A method for evaluating a driver in a vehicle equipped with an advanced driver assistance system, the method comprising:
collecting vehicle traveling information including a movement distance and movement time of the vehicle;
extracting a physical property value based on the vehicle traveling information;
receiving a notification from the advanced driver assistance system;
calculating a personal characteristic notification index value by non-dimensionalizing the notification according to the physical property value; and
calculating a reckless driving index value based on the personal characteristic notification index value, a weight for each notification, and a property correction coefficient.

2. The method of claim 1, wherein the non-dimensionalizing of the notification comprises:
determining a dimensional constant for non-dimensionalizing different dimensions for each notification; and
calculating the non-dimensionalized individual property notification index value by applying the movement distance, the movement time, and the dimensional constant to the notification.

3. The method of claim 2, wherein the personal characteristic notification index value Adi corresponding to an i-th received notification Ai is calculated by Equation 1:
$$A {d}_{i} = \frac{{A}_{i}}{{t}^{{p}_{i}} ∗ {d}^{{q}_{i}}} ∗ {K}_{i}$$
where pi is a dimensional constant corresponding to the movement time, qi is a dimensional constant corresponding to the movement distance, and Ki is a unit correction constant.

4. The method of claim 3, wherein the pi and the qi are dynamically updated based on at least one of a type of the notification corresponding to the vehicle traveling information, an accident occurrence frequency, a probability of occurrence of an accident, and a repair cost incurred per accident.

5. The method of claim 4, further comprising:
determining the weight for each notification; and
calculating the property correction coefficient for each notification,
wherein the determining of the weight for each notification comprises:
identifying an accident occurrence notification among the received notifications; and
determining the weight for each notification type through logistic regression analysis of accident data corresponding to the accident occurrence notification.

6. The method of claim 5, wherein the reckless driving index value Fd is calculated by Equation 2:
$$F d = {\sum }_{i = F C W}^{n} {α}_{i} ∗ {β}_{i} ∗ log \left(A {d}_{i} + {K}^{′}\right) ∗ {K}^{″}$$
where αi is the weight corresponding to the i-th notification, βi is a property correction coefficient corresponding to the i-th notification, and K′ and K″ are unit correction coefficients.

7. The method of claim 6, further comprising:
calculating a total reckless index of the corresponding driver based on the reckless driving index value calculated for each running, wherein the total reckless index Fdtotal is calculated by Equation 3:
$$F {d}_{t o t a l} = \frac{{\sum }_{i = 0}^{n} F {d}_{i} ∗ {d}_{i} ∗ {τ}^{i}}{{\sum }_{i = 0}^{n} {d}_{i} ∗ {τ}^{i}}$$
where n is the total number of times of running, Fdi is a reckless driving index value corresponding to an (n - i)-th running, di is a movement distance corresponding to the (n - i)-th running, and τ is a time constant between 0 and 1.

8. The method of claim 7, further comprising:
calculating a driver’s driving score based on the total reckless index Fdtotal, wherein the driving score Score is calculated by Equation 4:
$$\begin{matrix}S c o r e = ζ ∗ 100 \left(1 - \frac{1}{1 + {e}^{- \frac{F {d}_{t o t a l}}{\text{T}}}}\right) \\ ζ = \text{scoring constant 1} \\ \text{T} = \text{scoring constant 2}\end{matrix}$$
.

9. The method of claim 6, wherein the weight and the property correction coefficient are pre-calculated through machine learning on cumulative collected vehicle travel information, the notification, and the accident data, and then used to calculate the reckless driving index value.

10. The method of claim 1, wherein the notification includes at least one of a lane departure warning (LDW) notification, a forward collision warning (FCW) notification, a pedestrian collision warning (PCW) notification, a traffic sign recognition (TSR) notification, a speed limit warning (SLW) notification, and a headway monitoring & warning (HMW) notification.

11. A system for evaluating a driver, the system comprising:
a traveling information providing unit configured to collect and provide vehicle traveling information;
an advanced driver assistance system configured to output various notifications based on the vehicle traveling information; and
a device for evaluating the driver, the device configured to calculate notification non-dimensionalization and a personal characteristic notification index value through machine learning based on the vehicle traveling information and the notification, and calculate a total reckless index and a driver’s driving score based on a pre-calculated weight and property correction coefficient.

12. A device for evaluating a driver interworking with an advanced driver assistance system and a traveling information providing system, the device comprising:
a vehicle traveling information collection unit configured to collect vehicle traveling information including a movement distance and movement time of a vehicle from the traveling information providing system;
a physical property value extraction unit configured to extract a physical property value based on the vehicle traveling information;
a notification receiving unit configured to receive a notification from the advanced driver assistance system;
a personal characteristic notification index calculation unit configured to calculate a personal characteristic notification index value by non-dimensionalizing the notification according to the physical property value; and
a reckless driving index calculation unit configured to calculate a reckless driving index value based on the personal characteristic notification index value, a weight for each notification, and a property correction coefficient.

13. The device of claim 12, further comprising:
a weight determination unit configured to determine the weight for each notification; and
a property correction coefficient determination unit configured to determine the property correction coefficient for each notification.

14. The device of claim 12, further comprising:
a total recklessness index calculation unit configured to calculate a total recklessness index of the driver based on the reckless driving index value calculated for each running,
wherein the total reckless driving index value Fdtotal is be calculated by Equation 3:
$$F {d}_{t o t a l} = \frac{{\sum }_{i = 0}^{n} F {d}_{i} ∗ {d}_{i} ∗ {τ}^{i}}{{\sum }_{i = 0}^{n} {d}_{i} ∗ {τ}^{i}}$$
where n is the total number of times of running, Fdi is a reckless driving index value corresponding to an (n - i)-th running, di is a movement distance corresponding to the (n - i)-th running, and τ is a time constant between 0 and 1.

15. The device of claim 14, further comprising:
a driving score calculation unit configured to calculate a driver’s driving score based on the total reckless index Fdtotal, wherein the driving score Score is calculated by Equation 4:
$$\begin{matrix}S c o r e = ζ ∗ 100 \left(1 - \frac{1}{1 + {e}^{- \frac{F {d}_{t o t a l}}{\text{T}}}}\right) \\ ζ = \text{scoring constant 1} \\ \text{T} = \text{scoring constant 2}\end{matrix}$$
.

16. The device of claim 14, wherein the weight and the property correction coefficient are pre-calculated through machine learning on cumulative collected vehicle traveling information, the notification, and the accident data, and then used to calculate the reckless driving index value.
